(19) United States
(12) Patent Application Publication
(10) Pub. No.: US 2004/0244351 A1
(43) Pub. Date: Dec. 9, 2004

(54) Device for cultivating a grass cover

(76) Inventor: Jacob Jacobus Rodenburg, BM Geervliet (NL)

Correspondence Address: Ladas & Parry, 26 West 61st Street, New York, NY, 10023, US

(21) Appl. No.: 10/485,128

(22) PCT Filed: Jul. 17, 2002
(86) PCT No.: PCT/NL02/00454

(30) Foreign Application Priority Data
Aug. 7, 2001 (NL) 1018718

(51) Int. Cl. A01D 34/53

(52) U.S. Cl. 56/249

(57) ABSTRACT

Device for cultivating a grass cover (19), said device comprising a frame (1) to be coupled to a tractor (3), said frame supporting a driven shaft (17), which, during use of the device, extends square to the direction of movement of the frame and extends almost horizontally. Said shaft (17) is provided with a number of cultivating members (18), square to the axis of said shaft, at spaced-apart positions, which project into the grass cover and bring the ground below upwards to above said grass cover (19) during use. In front of the location where a cultivating member (18) is situated in the driven shaft (17), a cutting disc (12) is present which is rotatably supported by the frame (1) through a supporting shaft (6). Each cutting disc (12) is followed by a rising coulter (14), followed by a rotatably driven cultivating member (18) and subsequently means (20) for pressing the parts of the grass cover (19) that were turned upwards by the rising coulter (14).

The invention relates to a device for cultivating a grass cover, said device comprising frame to be coupled to a tractor, said frame supporting a driven shaft, which, during use of the device, extends square to the direction of movement of the frame and extends almost horizontally, said shaft being provided with a number of cultivating members, square to the axis of said shaft, at spaced-apart positions.

Such a device is known from NL-A-9401654. With this device, the cultivating members are constituted by milling cutters, which, during operation, project into the grass cover across a certain distance and bring the ground from below up to above the grass cover.

This device achieves good results in cultivation of sports fields, such as soccer fields, for example. The ground thrown up by milling cutters is distributed across the grass cover and the slots made in the ground can be closed sufficiently so that the sports field can be used again after a number of weeks. Unevennesses may remain at the site of the slots. This may have been caused by the milling cutters during the making of the slots, in which parts of the grass cover were pushed away or destroyed. Obviously, the milling cutters should have a certain depth for being able to bring ground upwards.

Although the presence of small unevennesses is of no importance with soccer fields, this is annoying in case of a golf course. A small unevenness will influence the course of the ball considerably.

The object of the invention is to remove this difficulty and to that end provides for, that in front of the location where a cultivating member is situated in the driven shaft, a cutting disc is present which is rotatably supported by the frame through an supporting shaft, in which each cutting disc is followed by a rising coulter, followed by a rotatably driven cultivating member and subsequently means for pressing the parts of the grass cover that were turned upwards by the rising coulter.

Thus, the cutting disc makes a cut in the grass cover and the subsequent rising coulter presses the parts of the grass cover lying next to the cut slightly upwards, so that a slot arises in the grass cover. The following milling cutter will therefore not, or only slightly, contact the grass cover itself, and thus not damage it. The milling cutter is capable of throwing the ground up to beyond the grass cover with ease while at the same time providing for mixing of the ground below the grass cover and for aeration of said ground. The pressing means arriving after the milling cutter will provide for, that an even grass cover is obtained again, while hardly any, or no visible tracks of cultivation will remain in the grass cover.

In order to provide for, that the rising coulter will gradually push away the parts of the grass cover after the cutting disc, so that the grass cover will not get damaged, the leading edge of the rising coulter facing the cutting disc will extend from the foremost and lowermost point obliquely backwards and upwards.

The angle enclosed between the leading edge of the rising coulter and its lower edge may be between e.g. 30° and 60°.

The thickness of the cutting disc will obviously as minimal as possible in order to prevent damage to the grass cover. However, the rising coulter will have to have a certain thickness for pushing the parts of the grass cover adjacent the cut upwards.

In order to prevent the rising coulter from breaking the ground open itself, it will be provided for, that in operational position of the device, the lower edge of the rising coulter will be located at a smaller depth in the ground than the cutting disc.

Generally, during operation the lowermost point of the cutting disc will be located at 50 mm deep in the ground at most.

In order to achieve, that the lowermost position of the cutting disc is always located e.g. 10 mm deeper in the ground than the lower edge of the rising coulter, it will preferably be provided for, that the rising coulter and the supporting shaft on which the cutting disc is situated, will be connected to the same supporting member of the frame.

It is noted, that the rising coulter need not definitely be plate-shaped across all of its heigth. Its lower edge can e.g. be designed such, that it becomes wider from the foremost point, thus forming a type of horizontal foot. This will depend on the cultural-technical circumstances.

Preferably, the supporting member, serving to support the supporting shaft upon which the cutting disc is located and for supporting the rising coulter, will be adjustable in vertical direction in relation to the frame

Due to this, the depth across which the milling cutters should be located in the grass cover can be adjusted, whereas the rising coulter is at the same time at the desired less large depth than the cutting disc.

Since parts of the grass cover pushed upwards will slightly spring back after passing the rising coulter, it will preferably be provided for, that the rising coulter has a larger thickness than the milling cutter following it.

Thus, e.g. the thickness of the rising coulter can be 8 mm and the thickness of the milling cutter 4 mm. Here, obviously the type of grass cover, its condition and like circumstances, will be taken into account.

For pressing the parts of the grass cover after the milling cutter has performed its task, one can use a roller extending across the full width of the frame, or separate rollers located in pairs immediately next to one another and at both sides of a cut made by a cutting disc. One can also use resilient pressure plates moving across the grass cover having such a shape, that the parts of the grass cover adjacent a cut will be pressed to their original positions again.

The various parts will preferably be resiliently connected to the frame, so that they can easily follow the top surface of the grass cover and exert the desired pressure onto the grass cover.

The cutting discs need not be driven, but will preferably be mounted secured against rotation on a supporting shaft rotably supported by the frame.

Owing to this, it is achieved that during operation all cutting discs will rotate and that there won't be any cutting disc coming to a standstill at a certain moment because of the resistance exerted on it by the grass cover is too small.

This can be achieved e.g. in that the supporting shaft rotatably supported by the frame will have a non-circular cross-section and in that the cutting discs are provided with an opening having its form adapted to the one of the shaft.

In order to be able to mount the cutting discs in the desired position on the supporting shaft, short lengths of tubing can be slid onto the supporting shaft, next to the cutting discs located near the ends of the supporting shaft, in which at least some of them will be secured in relation to the supporting shaft.

By mounting each cutting disc loosely on the supporting shaft, a cutting disc can be easily replaced after damage or becoming blunt.

The invention is further explained by way of an embodiment, illustrated in the drawing, in which:

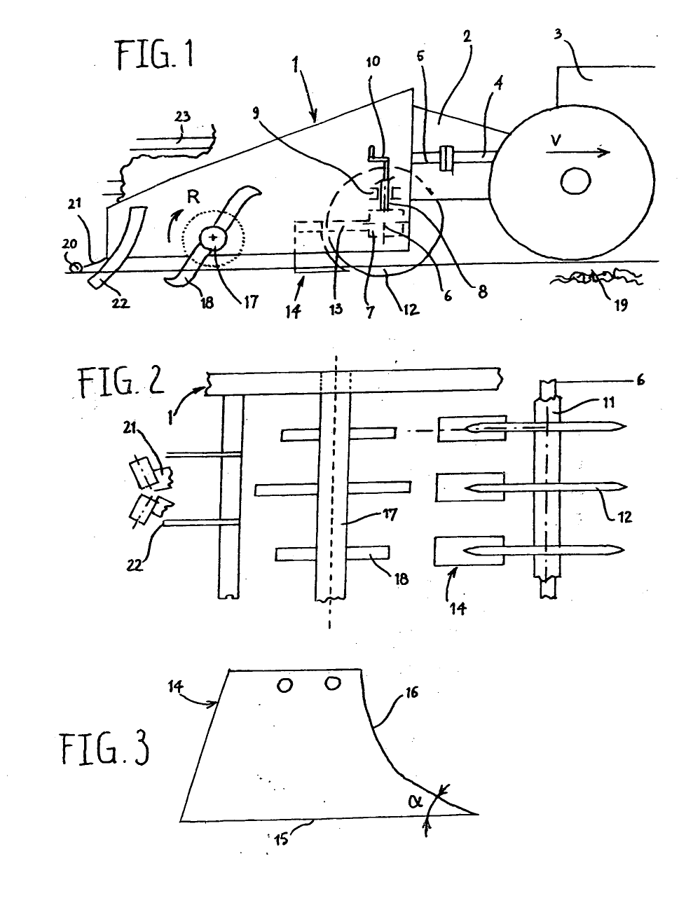

FIG. 1 shows schematically a lateral view of a device according to the invention;

FIG. 2 shows schematically a plan view of some parts of the device according of FIG. 1; and

FIG. 3 shows a lateral view of a rising coulter employed with the device according to FIGS. 1 and 2.

The device illustrated in the drawing comprises the frame 1, which can be connected to a tractor 3 by means of a well-known three-point suspension, indicated by 2. The drive shaft 4 extending from the tractor 3 can be connected to a drive shaft 5 which is supported in the frame 1.

Possibly, the frame 1 can be provided with wheels at its front and/or rear side for supporting the frame during moving it, namely in the direction as indicated by the arrow V. However, applying wheels is not absolutely necessary, as will appear from the following.

A supporting shaft 6 has its ends rotatably received in a supporting member 7 extending in the shape of a U. Said supporting member 7 is provided with at least one sliding part 8, which is slidable within a guide 9, which is connected to the frame 1. The guide 9 contains a threaded rod 10 which can be rotated by means of a grip or by means of an engine. The threaded rod 10 is connected to the sliding part 8 for vertical movement of supporting member 7. Obviously, supporting member 7 can be provided with more than one sliding part 8 having guides 9 and further parts.

The supporting shaft 6 can have a square cross-section, and short lengths of tubing 11 can be slid onto the supporting shaft, with said cutting discs in between, as appears in particular from FIG. 2. Said short lengths of tubing 11 and the openings made in the cutting discs will have a square cross-section internally, so that they are not rotatable on said shaft 6. In this way, the cutting discs can easily be replaced when they have been damaged or become blunt.

Further, the supporting member 7 is provided with a U-shaped bracket 13 to which rising coulters 14 can be connected by means of bolts not further indicated, one of said coulters being illustrated in detail in FIG. 3. The rising coulters are located directly behind the cutting discs 12. The lower edge 15 of the rising coulter 14 will extend almost horizontally during operation of the device, whereas the lowermost part of its leading edge 16 will enclose an angle α between about 30° and 60° with the lower edge 15. There, the lower edge 15 of a rising coulter will be at a smaller depth than the lowermost point of the accompanying cutting disc 12.

The lower edge of the rising coulter 14 can be provided with a foot extending almost horizontally, sligthly widening from the foremost point.

Frame 1 is further provided with a rotatably supported shaft 17 to which milling cutters 18 have been mounted as it has been described in said NL-A-9401654. Said milling cutters can be rotated in the direction of the arrow R. It is also possible to mount said milling cutters 18 in the other position and have them rotate in the opposite direction. The rotational speeld R will be adapted to the velocity V with which the device is moved across the grass cover 19 by the tractor 3.

On account of the weight of the frame 1 with the supporting shaft 6 and the parts fastened to it and other parts, the cutting discs 12 will generally sink into the grass cover across a depth of about 50 mm. The depth across which the milling cutters 18 project in the ground can be adjusted by adjusting the sliding part 8 in height, so that the cutting discs will be adjusted in height in relation to the frame.

After the milling cutters 18, there are means for closing the slot made in the grass cover. These means can be e.g. rollers 20, having their rotary shafts mounted to resilient strips 21, which are connected to the frame in a way not further illustrated. The rollers 20 are lying close to one another and can enclose a small angle. The rollers 20 can also be replacedy resilient pressure plates, as already indicated above. The rollers 20 or the pressure plates can serve simultaneously for supporting the rear end of frame 1.

As described in said NL-A-9401654, further knive coulters 22 can be connected to the frame, which are located between milling cutters 18 and serve for pushing the ground laterally towards the slots made. Naturally, this will take place only if this is useful in a specific case.

The ground cast upwards from the slot can possibly be collected on a conveyor 23 which has only been indicated schematically. Its operation has already been described in NL-A-9401654.

It will be obvious, that the assembly of cutting discs and rising coulters can also be applied with other devices than the device described hereinbefore, and that only one possible embodiment of the device according to the invention has been illustrated in the drawing and described above. Thus, many modifications can be made without leaving the inventive idea, as it is indicated in the claims.

1. Device for cultivating a grass cover (19), said device comprising a frame (1) to be coupled to a tractor (3), said frame supporting a driven shaft (17), which, during use of the device, extends square to the direction of movement of the frame and extends almost horizontally, said shaft (17) being provided with a number of cultivating members (18), square to the axis of said shaft, at spacedapart positions, characterized in that in front of the location where a cultivating member (18) is situated in the driven shaft (17), a cutting disc (12) is present which is rotatably supported by the frame (1) through a supporting shaft (6), in which each cutting disc (12) is followed by a rising coulter (14), followed by a rotatably driven cultivating member (18) and subsequently means (20) for pressing the parts of the grass cover (19) that were turned upwards by the rising coulter (14).

2. Device according to claim 1, characterized in that the leading edge (16) of the rising coulter (14) facing the cutting disc (12) will extend from the foremost and lowermost point obliquely backwards and upwards.

3. Device according to claim 2, characterized in that the angle (a) enclosed between the leading edge (16) of the rising coulter (14) and its lower edge (15) may be between e.g. 30° and 60°.

4. Device according claim 1, characterized in that in operational position of the device, the lower edge (15) of the rising coulter (14) will be located at a smaller depth in the ground than the cutting disc (12).

5. Device according to claim 1, characterized in that the lower edge of the rising coulter is provided with a foot extending almost horizontally, sligthly widening from the foremost point of the rising coulter.

6. Device according to claim 1, characterized in that the rising coulter (14) and the supporting shaft (6) on which the cutting disc (12) is located, are connected to the same supporting member (7) of the frame (1).

7. Device according to claim 6, characterized in that said supporting member (7), serving for supporting the supporting shaft (6) on which the cutting disc (12) is located and for supporting said rising coulter (14), is adjustable in vertical direction in relation to the frame (1).

8. Device according to claim 1, characterized in that said rising coulter (14) has a greater thickness than the cultivating member (18) following it.

9. Device according to claim 1, characterized in that for pressing the parts of the grass cover (19) after the cultivating member (18) has passed, a roller extending across the full width of the frame (1) is used.

10. Device according to claim 1, characterized in that for pressing the parts of the grass cover (19) after the cultivating member (18) has passed, separately arranged rollers (20) or pressing plates are used, extending in pairs adjacent or through a cut made by a cutting disc (12).

11. Device according to claim 9, characterized in that the parts (20) providing for pressing the parts of the grass cover (19) after the cultivating member (18) has passed, are resiliently connected to the frame (1).

12. Device according to claim 1, characterized in that the cutting discs (12) are mounted secured against rotation on a supporting shaft (6) which is rotatably supported by said frame (1).

13. Device according to claim 12, characterized in that the supporting shaft (6) rotatably supported by the frame (1) has a non-round cross-section and that the cutting discs (12) are provided with an opening having a shape adapted to the shape of said supporting shaft (6).

14. Device according to claim 13, characterized in that short lengths of tubing (11), their internal cross-sections being adapted to the external cross-section of said supporting shaft (6), have been slid onto said supporting shaft, between and adjacent cutting discs (12) situated near the ends of said supporting shaft, at least some of said cutting discs (12) being secured in relation to the supporting shaft (6).
